(19) United States
(12) Patent Application Publication
(10) Pub. No.: US 2011/0129290 A1
(43) Pub. Date: Jun. 2, 2011

(54) Tabbed Dividers for Use with Protective Sleeves

(76) Inventor: Mark Danko, Winnipeg (CA)

(21) Appl. No.: 12/954,357

(22) Filed: Nov. 24, 2010

Related U.S. Application Data
(60) Provisional application No. 61/265,127, filed on Nov. 30, 2009.

(51) Int. Cl. B42F 13/00

(52) U.S. Cl. 402/79

(57) ABSTRACT

Tabbed dividers for use with protective sleeves of the type each comprising a receiving portion having front and rear sheets closed together along sealed edges thereof and left open along at least one unsealed edge for receipt of one or more pages between the sheets and a securing portion extending along a lengthwise one of said sealed edges of the retaining portion with a sleeve retaining feature for cooperation with a retaining mechanism of a binder. The tabbed dividers each comprise a separator page having a divider retaining feature thereon and a tab connected to the separator page to project outward therefrom at a widthwise edge thereof by a distance great enough to project outwardly past a respective widthwise edge of the receiving portion of the protective sleeve with the protective sleeve and the divider arranged face to face to align the sleeve retaining features and the divider retaining features.

This application claims benefit under 35 U.S.C. 119(e) of U.S. Provisional Patent Application Ser. No. 61/265,127, filed Nov. 30, 2009.

### FIELD OF THE INVENTION

This invention relates generally to tabbed dividers, and more particularly to tabbed dividers having tabs of improved visibility and accessibility when used to divide a stack of protective sleeves containing printed material in 3-ring binders and zippered and non-zippered portfolios.

### BACKGROUND OF THE INVENTION

Printed materials are often carried in a three ring binder which retains a stack of such materials by means of three openable rings spaced along the spine of the binder and passing through holes punched through the sheets of printed materials in sets of three holes per page. However, it is also often desirable to use a binder to store and display printed materials that are preferably left in their original, intact state to preserve the original integrity, condition and appearance of the of the materials. Protective sleeves have thus been used for such purposes. Such sleeves typically feature a receiving portion defining a pocket between two sheets of transparent material such that the printed sheet or other planar item can be slid into the pocket of the sleeve for safe keeping between the sheets to avoid direct contact of the item by a viewer's fingers and exposure of the item to dust, airborne particles, fluids, damage, general wear and tear, etc. Along one side of the pocket-defining receiving portion of the sleeve is a retaining portion that features three holes passing therethrough for cooperation with the three rings of the binder's retaining mechanism so that binder rings can pass through these holes to retain the protective sleeve, which in turn supports the printed item. Printed items are thus retained with the binder without direct engagement by the rings thereof, and so the printed items can be left unpunched in their original intact form.

Tabbed dividers are often used to index larger volumes of printed materials within a binder to allow quick and easy access to a particular section of such a volume containing one particular item or a series of related items. A tabbed divider for a binder conventionally features a generally rectangular separator or divider page having a retaining portion again featuring three holes spaced along one of the two opposing longer edges of the page and a tab projecting outward from the other of these two longer edges of the page, away from the retaining portion. The intention is that the divider is sized so that the tab will project to a position beyond the respective edge of the face-to-face items, sleeved or unsleeved, so as to be unobstructed by the items and thus visible and accessible to a side of the items opposite the binder's ring-based retaining mechanism. Conventional tabbed dividers sized for use with unsleeved pages or sheets do not extend far enough from the binder's retaining mechanism to be readily visible and accessible due to the width added to the sleeved page(s), sheet(s) or item(s) by combined width of the sleeve's receiving and retaining portions. Extra wide tabbed dividers are available to overcome this problem by positioning the tab's label portion outward from the stack of sleeved printed materials, but this can cause other complications when used in a conventionally sized binder, as the tabs of the dividers may project beyond the peripheral edges of the binder covers. In a zipper equipped binder featuring a zipper closure along the peripheral edges of the binder covers, these tabs positioned at the edges of the binder covers opposite the binder's spine may become caught in and damaged by the zipper, may necessitate folding or bending of the protective sleeves within the binder in order to close the zipper, or may prevent closing of the zipper altogether. In a zipper free binder, the projection of the tabs of the extra wide divider outward from between the covers may leave the tabs susceptible to damage.

### SUMMARY OF THE INVENTION

According to a first aspect of the invention there is provided a set of tabbed dividers for use with a set of protective sleeves, said protective sleeves each comprising a receiving portion having front and rear sheets closed together along sealed edges thereof and left open along at least one unsealed edge for receipt of one or more pages between the sheets and a securing portion extending along a lengthwise one of said sealed edges of the retaining portion and having a sleeve retaining feature for cooperation with a retaining mechanism of a binder, the tabbed divider set comprising a plurality of dividers each comprising a separator page having a divider retaining feature thereon and a tab connected to the separator page to project outward therefrom at a widthwise edge thereof by a distance great enough to project outwardly past a respective widthwise edge of the receiving portion of the protective sleeve with the protective sleeve and the divider arranged face to face to align the sleeve retaining features and the divider retaining features.

According to a second aspect of the invention there is provided a set of tabbed dividers in combination with a set of protective sleeves;

said sleeves each comprising:
a receiving portion having front and rear sheets closed together along sealed edges thereof and left open along at least one unsealed edge for receipt of one or more pages between the sheets; and
a securing portion extending along a lengthwise one of said sealed edges of the retaining portion and having a sleeve retaining feature for cooperation with a retaining mechanism of a binder;

said plurality of dividers each comprising:
a separator page having a divider retaining feature thereon; and
a tab connected to the separator page to project outward from a widthwise edge thereof past a respective widthwise edge of the receiving portion of the protective sleeve with the protective sleeve and the divider arranged face to face with the sleeve retaining features and the divider retaining features aligned.

According to a third aspect of the invention there is provided a set of tabbed dividers in combination with a set of protective sleeves and a binder, the tabbed dividers and the protective sleeves being arranged face-to-face within a stack coupled to the binder by a retaining mechanism thereof proximate a spine of the binder,

said protective sleeves each comprising:
a receiving portion having front and rear sheets closed together along sealed edges thereof and left open along at least one unsealed edge for receipt of one or more pages between the sheets; and
a securing portion extending along a lengthwise one of said sealed edges of the retaining portion and having a sleeve retaining feature engaged by the retaining mechanism of the binder;

said tabbed dividers each comprising:
a separator page arranged face to face with a respective protective sleeve and having a divider retaining feature thereon aligned with the sleeve retaining features of the protective sleeves and engaged by the retaining mechanism of the binder; and
a tab connected to the separator page to project outward from a widthwise edge thereof past a respective widthwise edge of the receiving portion of the respective protective sleeve, the tab being positioned inward from peripheral edges of covers of the binder when closed.

The binder may comprise a zipper operably installed along the peripheral edges of the covers for further closing of the binder, the tab of each tabbed divider being positioned inward from the zipper when closed.

Preferably the tab of each tabbed divider is positioned inward from the peripheral edges of one of the covers of the binder when said tabbed divider extends along said one of the covers in a planar manner parallel thereto.

The receiving portion of each protective sleeve may be sized to receive an 8.5 by 11 inch page, the widthwise edge of the separator page of each tabbed divider exceeding 8.5 inches in length.

Preferably the tabs of adjacent tabbed dividers in the stack are non-overlapping along the widthwise edges thereof.

Preferably the divider retaining feature of each tabbed divider comprises a plurality of linearly spaced apart apertures for passage of rings of the retaining mechanism of the binder therethrough.

Preferably the widthwise edge of the separator page equals or exceeds the respective widthwise edge of the protective sleeve in length.

Preferably a width of the separator page substantially spans a full combined width of the receiving portion and the sleeve retaining portion of the protective sleeve along the widthwise edge of the receiving portion.

Preferably the separator page substantially spans a full length of the protective sleeve along the lengthwise edge thereof.

The tabbed dividers may exceed or be equal to the protective sleeves in width.

The tabbed dividers may exceed or be equal to the protective sleeves in length.

Preferably the widthwise edge of the separator page of each tabbed divider from which the tab projects is a top edge of said separator page.

### BRIEF DESCRIPTION OF THE DRAWINGS

In the accompanying drawings, which illustrate exemplary embodiments of the present invention:

FIG. 1 is a schematic plan view of a protective sleeve with a tabbed divider according one embodiment of the present invention.

FIG. 2 is a schematic plan view of the protective sleeve and tabbed divider of FIG. 1 with a printed brochure received in the protective sleeve.

FIG. 3 is a schematic plan view of the protective sleeve, tabbed divider and printed sheet of FIG. 2 secured by the retaining mechanism of a three ring portfolio binder.

FIG. 4 is a schematic plan view of a set of tabbed dividers according to an embodiment of the present invention.

### DETAILED DESCRIPTION

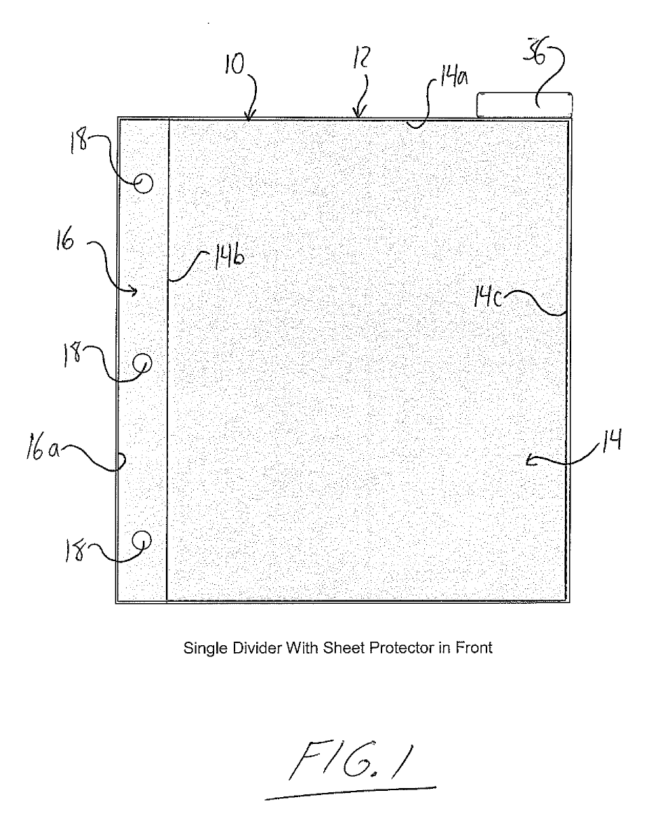

FIG. 1 shows a conventional protective transparent sleeve 10 placed atop a tabbed divider 12 of an embodiment of the present invention in a parallel face-to-face stacked arrangement therewith. The conventional protective sleeve 10 features a rectangular receiving portion 14 made of two transparent, flexible and equally sized rectangular sheets of vinyl plastic or other flexible transparent material sealed together along three of their four aligned sides. Along a fourth top side 14a, defining one of the two shorter sides of each sheet's elongated rectangular shape, the sheets are left unsealed to define an opening through which a brochure, sheet, page, document or other printed material can be inserted into the pocket defined by the cooperating sheets for storage and safe-keeping therebetween. A narrow rectangular strip, narrow relative to the wider receiving portion 14, is fixed to one of the two longer sealed sides 14b thereof to extend therealong so that the relatively narrow width of the strip projects away from the opposite longer side 14c of the rectangular receiving portion 14. This strip defines a retaining portion 16 of the sleeve 10 and may be formed by sealed together integral extensions of the sheets defining the receiving portion 14, one of the two lengthwise sides of the strip thus being defined by the respective sealed together lengthwise side 14b of the receiving portion 14. The integral extensions of the sheets forming the two faces of the strip are preferably also sealed together along an opposite lengthwise side 16a thereof, and the strip may be reinforced by an elongate piece of paper or cardstock received between the parallel seals between the integral sheet extensions on the opposite elongated sides of the strip. This conventional sleeve structure is completed by three holes or apertures 18 passing through the retaining strip 16 at equally and linearly spaced positions therealong for passage of the rings of a three ring binder's sheet-retaining mechanism therethrough to secure the sleeve to the binder between the cover panels thereof.

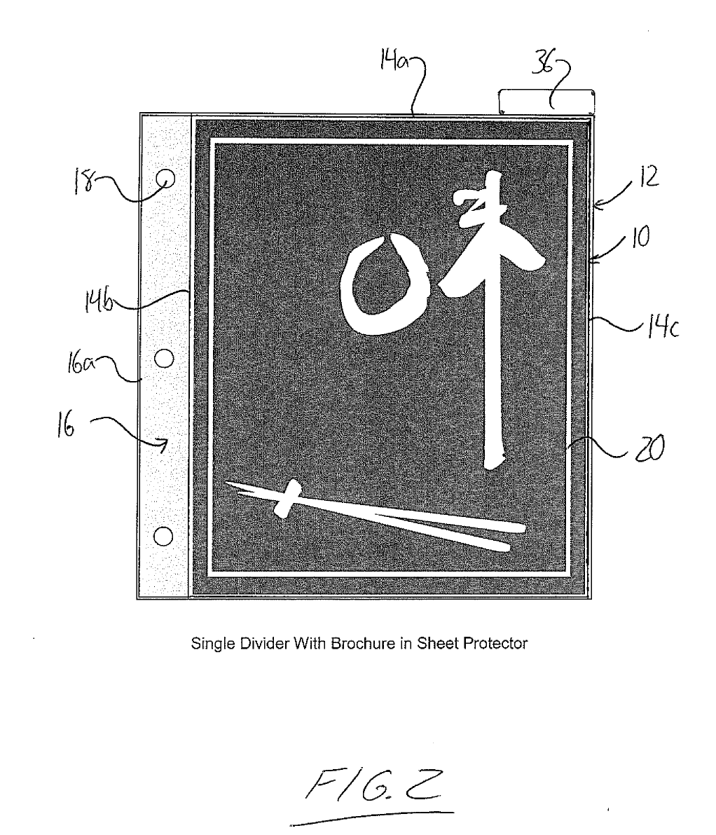

In FIG. 2, the sleeve 10 is shown carrying a brochure 20 having letter sized pages of 8.5 inches in width and 11 inches in length, the widthwise and lengthwise edges of the receiving portion 14 of the sleeve 10 slightly exceeding these dimensions respectively to accommodate the brochure 20 therein. This known size of sleeve corresponds to use with documents or printed items of a commonly used sheet size or standard in North America, but it will be appreciated that sleeves of other dimensions are known and that the tabbed dividers described herein can accordingly be adjusted in size for use with such alternate sleeve sizes. It will also be appreciated that the sleeves and dividers may be used with sheet-like or page-containing items other than brochures or promotional materials, and that the sleeves need not necessarily be transparent if intended only for safe storage and not for actual viewing of the sleeve's contents without removal, although transparent sleeves are the most common as they allow for such viewing of text matter or imagery on outward facing surfaces or pages of the stored item without removal from the sleeve. The brochure 20 in the figures illustrates how the presence of the sleeve's retaining portion 16 allows for storage in a binder without punching or otherwise forming appropriately sized holes or apertures in the printed material, thereby preserving the integrity of its sheet(s) or page(s).

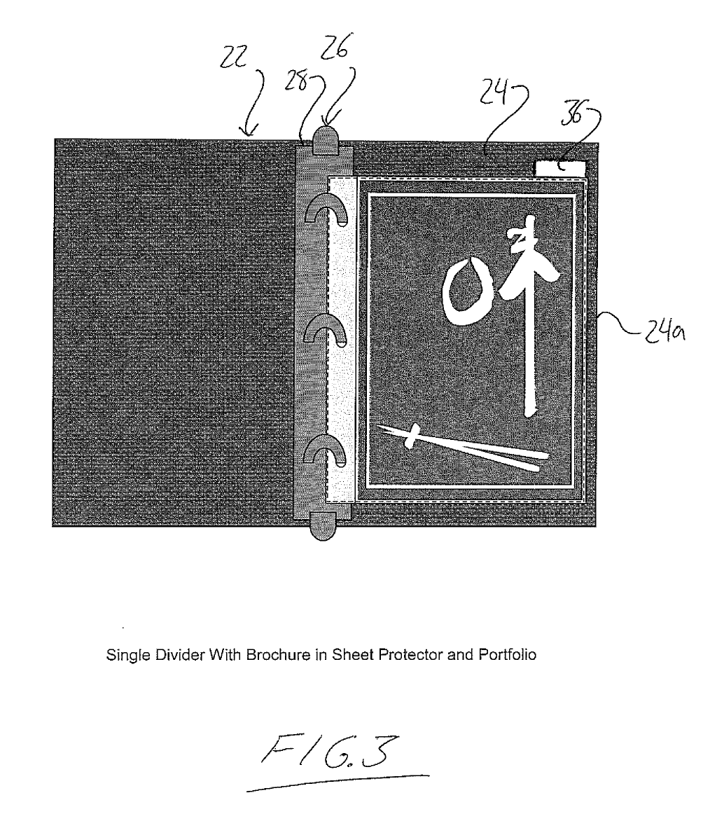

Like the conventional sleeves, conventional tabbed dividers and conventional binders are sold in pre-defined uniform sizes corresponding to standard sheet or page sizes. For example, a binder intended for use with 8.5 by 11 inch letter sized sheets or pages will have cover panels dimensioned to exceed these width and length dimensions by a small amount so as to fully cover the sheets or pages stacked in a face-to-face arrangement and secured in this stacked configuration by the ring's of the binder's retaining mechanism. However, as illustrated by the conventional sleeve 10 and binder 22 of FIG. 3, the larger width of the sleeved brochure 20 or printed material due to the retaining portion 16 of the sleeve projecting laterally from the sleeve's retaining portion takes up nearly the full width of the rear cover 24 of the binder 20 when resting face to face thereatop. That is, the sleeve 10 extends from the retaining mechanism 26 of the binder 22 at or proximate the spine 28 connected between the binder's cover panels such a significant distance that the outer lengthwise edge 14c of the sleeve's receiving portion opposite the retaining portion 16 is situated in close proximity to the respective lengthwise edge 24a of the binder's rear cover opposite the spine 28. A standard letter sized tabbed divider having its tab in the conventional position at the lengthwise edge of the divider opposite the retaining portion secured to the binder's retaining mechanism would not have a width sufficient to project the tab past the outer lengthwise edge 14c of the sleeve 10. While use of a wider tabbed divider with its tab likewise at the outer edge of the divider opposite the connection of its retaining portion to the binder's retaining mechanism would overcome this problem, the tab of such an extra-wide divider would either also project past the outer lengthwise edge 24a of the binder's rear cover 24, or be limited to a very small projection beyond the sleeve's outer edge 14c so as not to project past the cover's edge. The former of these two possible arrangements would leave the tab susceptible to damage outside the binder, as the projection of the tab outward from between the binder covers would leave it unprotected by the covers, which may lead to bending, tearing or wear of the tab when the binder is closed and manually gripped at the open end of the binder left between the outer lengthwise edges of the binder covers, which is a common way of carrying a binder. In the context of a zipper-equipped binder portfolio where the binder covers are fitted with a zipper extending along the three outer edges of each cover (i.e. all sides of the cover except for that at which it connects to the spine) to allow further closing of the binder along the peripheral edges thereof, the former of the two arrangements would situate the tab of the tabbed divider at a position that would prevent closing of the zipper, cause damage to the tab during closing of the zipper or require bending or folding of the sleeved sheets of printed material out of their normal substantially planar conditions lying generally flat between binder covers. The latter of the two arrangements may avoid these problems, but only by significantly reducing the projecting distance of each tab, therefore limiting the space available for labelling of the tab, therefore requiring smaller print labelling that may be difficult to read. This reduced projecting height of the tab from the separator page also provides a reduced gripping area by which a user can grab the tabbed divider to open the stack of sleeved printed materials to a desired section or page.

The tabbed divider 12 of the embodiment of the present invention shown in FIG. 3 is thus not configured to have its tab at the conventional position projecting from the lengthwise edge of the divider's rectangular page body, the tab instead projecting perpendicularly from a widthwise top edge of the divider's rectangular page body. The divider 12 features an elongate rectangular separator or divider page 32 having a width equal to the overall width of the sleeve 10 (i.e. the combined widths of the receiving and retaining portions 14, 16 of the sleeve 10) and a length equal to that of the sleeve 10, as defined by the equal lengthwise edges of the rectangular receiving portion 14. The slight differences in the illustrated lengths and widths of the sleeve 10 and separator page 32 in FIGS. 1 to 3 are shown only to better visually distinguish the transparent sleeve from the separator page 32 of the divider 12. Like the sleeve, the separator page 32 of the divider 12 features three holes or apertures 34 spaced linearly from one another along an inner lengthwise edge 32a of the separator page 32 at a short distance from this edge along a axis parallel thereto. The spacing of these holes 34 matches those of sleeve and the hole sizes are again chosen to facilitate passage of the binder's sheet securing rings therethrough. With the holes 18, 34 of the sleeve 10 and the divider's separator page 32 aligned, the peripheral edges of these two planar elements also align.

The tab 36 of each divider 12 projects perpendicularly outward from a top widthwise edge 32b of the rectangular separator sheet 32 over a partial fraction of this edge's length. With reference to FIG. 3, with the equal sizing of the sleeve 10 and the separator sheet 32 of the divider 12, the tab 36 is thus situated in a position that projects upward away from the open top widthwise edge 14a of the sleeve 10 when the separator page 32 and the sleeve are placed on atop the other in a face to face configuration within a stack of sleeved planar or sheet-like items secured to the binder 22, the sleeve and the divider being sufficiently aligned to communicate the holes of the sleeve with those of the divider to allow passage of the rings through the communicating holes. As shown in FIG. 3, adequate spacing for the tab 36 is left at this top portion of the binder covers between the top widthwise edges 14a of the sleeves and the respective top widthwise edge 24b of the rear binder cover 24 because the sleeve are of equal or at least very similar height to the pages of printed material, and the binder covers are intended to fully cover pages of this size and therefore have lengthwise dimensions exceeding the sleeve's lengthwise dimension to extend both upwardly and downwardly past the sleeve along the sleeve's lengthwise edges 14b, 14c. As a result, the tabs are positioned entirely inward from the periphery of the binder, with space left between each tab and the top widthwise edge of the binder cover. The tabs thus do not project outward from between the binder covers when closed, and do not interfere with operation of a zippered binder. The tabbed divider takes advantage of the fact that the conventional structure of a binder intended for use with pages of a particular uniform size will lose a significant portion of its usable interior width when used with protective sleeves intended for that particular size of page, but will retain generally the same usable interior height.

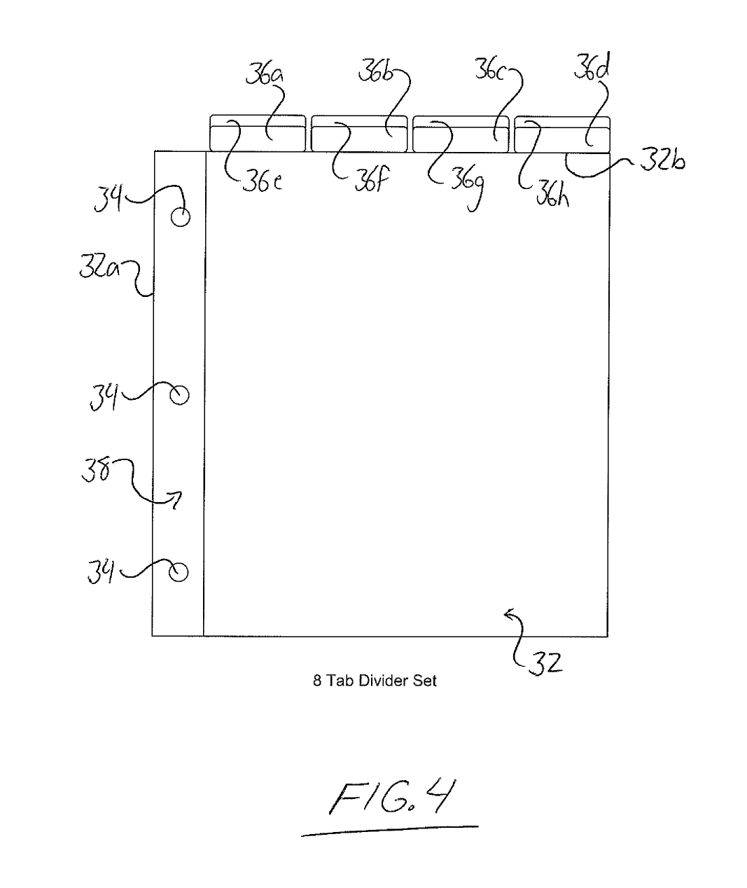

FIG. 4 shows a set of eight tabbed dividers of the type described herein above. With the tabbed dividers stacked atop one another with the peripheral edges and the apertures of the dividers generally aligned, it can be seen that the tabs 36a, 36b, 36c, 36d of the four topmost dividers are positioned along the top widthwise edge of the respective separator pages so as not to overlap one another along this edge, the tab 36a of the topmost divider being adjacent the retaining portion of the separator page that would overlie the retaining portion of the sleeve if placed in alignment thereover, and the tabs 36b, 36c, 36d of the next sequential three tabbed dividers moving downward through the stack or pile of dividers are sequentially closer to the lengthwise edges of the tabbed dividers opposite their hole-punched retaining portions. The next and final four tabbed dividers 36e, 36g, 36g, 36h in the stack are similarly arranged, sequentially starting again with the fourth from the top divider tab 36e positioned adjacent the retaining portion of the respective separator page and the final or bottom tabbed divider having its divider tab 36h at or adjacent the lengthwise edge of the stack opposite the retaining portions. The second or lowermost subset of four tabs 36e, 36f, 36g, 36h have equal heights that exceed those of the first or uppermost subset of four tabs 36a, 36b, 36c, 36d, thus projecting further from the top widthwise edges of the separator pages so that distal upper portions of the second set of tabs are visible past the first set of tabs when viewing the stack in plan from the front or top thereof. It will be appreciated that the number of tabbed dividers in a set may be varied, and that when more than one sequential row of dividers extending along the respective edge of the stack is used, they the different rows need not necessarily have different tab heights, i.e. the tabs could instead all have equal dimensions.

As is known in the art, the tabs may be of different shapes, for example rectangular, generally rectangular with curved or rounded corners at the distal edge of the tab opposite the widthwise edge of the separator sheet, trapezoidal, or generally trapezoidal with the aforementioned rounded corners. The tabs may also be of different types, for example a sleeve type tab formed by a folded over sheet of transparent material having its opposite ends on opposite sides of its fold or bend adhesively secured to opposite faces of the separator page with the fold or bend situated outward from and parallel to the separator page's widthwise edge such that a hollow sleeve is formed between the two sides of the folded sheet and is bound on two sides by the fold of the tab and either the widthwise edge of the separator page or a sealing together of the two sides of the folded sheet adjacent this page edge, with openings of the sleeve left at the opposite ends of the fold. These sleeve style tabs are typically rectangular and come with rectangular paper or cardstock inserts that can be written on or otherwise labeled and then slid into the sleeve defined by the tab. Should it be desirable to change the index label of a particular tab, the insert can be removed and replaced with a new or re-labeled insert. Alternatively, the tabs can be write-on types that can simply be written on or have a label directly applied to a face thereof. Write on tabs can be integral with the separator page or otherwise fastened thereto, for example by adhesive. The tabs can be provided in different colours, for example white write-on tabs provide significant contrast with dark ink for ease of readability, while colours may offer aesthetic effects and differently coloured write-on tabs may be more quickly and easily distinguished from on another. Sleeve type tabs may be of substantially clear or colourless transparent sheet material, or may be produced in different colours. Differently coloured sleeve tabs allows are again easily distinguished from one another, allowing for possible quick and easy recognition of a particular tab without reading its label, and using coloured sleeves instead of coloured inserts allows production of inserts in only a single colour, for example white. Tabs with preprinted index labels may also be used.

The retaining portion of each separator page 32, where the holes or apertures 24 are provided, may be reinforced. For separator pages produced from paper sheets or cardstock panels, this reinforcement may be provided in the form of a laminated edge portion 38 of the separator page laminated along the inner lengthwise edge 32a thereof and through which the holes or apertures are formed. As indicated above, this laminated portion may have the same dimensions as the strip-like retaining portion 16 of the sleeve 10.

Prototypes of a vertical set of tabbed dividers for use in zippered portfolios and binders with vinyl sleeves have been produced using stick-on sleeve style tabs and heavy weight card stock with a three-hole re-enforced edge for durability. The prototype was produced as an eight tab set in assorted colours with blank inserts. Intended for use with letter size 8½ by 11 inch printed material and accordingly sized conventional protective sleeves, each separator sheet is approximately 9¼ inches wide and 11⅛ inches high with the tabs having a ½-inch projection upward from the top of the separator page.

Although the tabbed dividers have been described above as having the tabs positioned at the top of the two widthwise edges projecting perpendicularly away from the retaining portion secured to the binder rings, it will be appreciated that the tabs may alternatively be positioned at the bottom of the two widthwise edges to project vertically downward from the separator sheet when vertically oriented.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A set of tabbed dividers for use with a set of protective sleeves, said protective sleeves each comprising a receiving portion having front and rear sheets closed together along sealed edges thereof and left open along at least one unsealed edge for receipt of one or more pages between the sheets and a securing portion extending along a lengthwise one of said sealed edges of the retaining portion and having a sleeve retaining feature for cooperation with a retaining mechanism of a binder, the tabbed divider set comprising a plurality of dividers each comprising a separator page having a divider retaining feature thereon and a tab connected to the separator page to project outward therefrom at a widthwise edge thereof by a distance great enough to project outwardly past a respective widthwise edge of the receiving portion of the protective sleeve with the protective sleeve and the divider arranged face to face to align the sleeve retaining features and the divider retaining features.

2. A set of tabbed dividers in combination with a set of protective sleeves;
said sleeves each comprising:
a receiving portion having front and rear sheets closed together along sealed edges thereof and left open along at least one unsealed edge for receipt of one or more pages between the sheets; and
a securing portion extending along a lengthwise one of said sealed edges of the retaining portion and having a sleeve retaining feature for cooperation with a retaining mechanism of a binder;
said plurality of dividers each comprising:
a separator page having a divider retaining feature thereon; and
a tab connected to the separator page to project outward from a widthwise edge thereof past a respective widthwise edge of the receiving portion of the protective sleeve with the protective sleeve and the divider arranged face to face with the sleeve retaining features and the divider retaining features aligned.

3. A set of tabbed dividers in combination with a set of protective sleeves and a binder, the tabbed dividers and the protective sleeves being arranged face-to-face within a stack coupled to the binder by a retaining mechanism thereof proximate a spine of the binder,
said protective sleeves each comprising:
a receiving portion having front and rear sheets closed together along sealed edges thereof and left open along at least one unsealed edge for receipt of one or more pages between the sheets; and
a securing portion extending along a lengthwise one of said sealed edges of the retaining portion and having a sleeve retaining feature engaged by the retaining mechanism of the binder;
said tabbed dividers each comprising:
a separator page arranged face to face with a respective protective sleeve and having a divider retaining feature thereon aligned with the sleeve retaining features of the protective sleeves and engaged by the retaining mechanism of the binder; and
a tab connected to the separator page to project outward from a widthwise edge thereof past a respective widthwise edge of the receiving portion of the respective protective sleeve, the tab being positioned inward from peripheral edges of covers of the binder when closed.

4. The set of tabbed dividers according to claim 3 wherein the binder comprises a zipper operably installed along the peripheral edges of the covers for further closing of the binder, the tab of each tabbed divider being positioned inward from the zipper when closed.

5. The set of tabbed dividers according to claim 3 wherein the tab of each tabbed divider is positioned inward from the peripheral edges of one of the covers of the binder when said tabbed divider extends along said one of the covers in a planar manner parallel thereto.

6. The set of tabbed dividers according to claim 1 wherein the receiving portion of each protective sleeve is sized to receive an 8.5 by 11 inch page, the widthwise edge of the separator page of each tabbed divider exceeding 8.5 inches in length.

7. The set of tabbed dividers according to claim 3 wherein the tabs of adjacent tabbed dividers in the stack are non-overlapping along the widthwise edges thereof.

8. The set of tabbed dividers according to claim 1 wherein the divider retaining feature of each tabbed divider comprises a plurality of linearly spaced apart apertures for passage of rings of the retaining mechanism of the binder therethrough.

9. The set of tabbed dividers according to claim 1 wherein the widthwise edge of the separator page exceeds the respective widthwise edge of the protective sleeve in length.

10. The set of tabbed dividers according to claim 1 wherein the widthwise edge of the separator page is equal to the respective widthwise edge of the protective sleeve in length.

11. The set of tabbed dividers according to claim 3 wherein a width of the separator page substantially spans a full combined width of the receiving portion and the sleeve retaining portion of the protective sleeve along the widthwise edge of the receiving portion.

12. The set of tabbed dividers according to claim wherein the separator page substantially spans a full length of the protective sleeve along the lengthwise edge thereof.

13. The set of tabbed dividers according to claim 1 wherein the tabbed dividers exceed the protective sleeves in width.

14. The set of tabbed dividers according to claim 1 wherein the tabbed dividers and the protective sleeves are equal in width.

15. The set of tabbed dividers according to claim 1 wherein the tabbed dividers and the protective sleeves are equal in length.

16. The set of tabbed dividers according to claim 1 wherein the tabbed dividers exceed the protective sleeves in length.

17. The set of tabbed dividers according to claim 1 wherein the widthwise edge of the separator page of each tabbed divider from which the tab projects is a top edge of said separator page.
